(19) United States
(12) Patent Application Publication
(10) Pub. No.: US 2004/0101172 A1
(43) Pub. Date: May 27, 2004

(54) Imaging system with locator bar for accurate fingerprint recognition

(75) Inventor: Fred P. Lane, Highland Village, TX (US)

Correspondence Address: Lisa K. Jorgenson, STMicroelectronics, Inc., 1310 Electronics Drive, Carrollton, TX, 75006, US

(73) Assignee: STMicroelectronics, Inc., Carrollton, TX

(21) Appl. No.: 10/335,587

(22) Filed: Dec. 31, 2002

Related U.S. Application Data
(60) Provisional application No. 60/429,155, filed on Nov. 26, 2002.

(51) Int. Cl. G06K 9/00

(52) U.S. Cl. 382/124

(57) ABSTRACT

A finger imaging system for receiving the finger of a person being fingerprinted by an automated fingerprint reader. The system includes a finger imaging device having a finger receiving portion for receiving the finger to be fingerprinted. Extending outward from the finger receiving surface is a locator bar that is located to engage a crease of the subject finger when it is in approximately the desired position. The locator bar may be fixed by or movably attached to the finger receiving surface, or may protrude through the finger receiving surface, possibly being attached to an interior movement mechanism. The locator bar may clean the finger as it is being positioned, and may include sensors for sensing non-image information to verify the legitimacy of an offered finger. The locator bar may also include a shunt for diverting unwanted static electricity stored on the finger before it is positioned for fingerprinting.

### PRIORITY CLAIM TO PROVISIONAL PATENT APPLICATION

This patent application claims priority to U.S. Provisional Patent Application Serial No. 60/429,155 filed on Nov. 26, 2002.

### CROSS-REFERENCE TO RELATED PATENT APPLICATION

The invention disclosed in the present patent application is related to the invention disclosed in U.S. patent application Ser. No. [Attorney Docket No. STMI01-01116], filed concurrently herewith, entitled “IMAGING SYSTEM WITH GUIDE FOR ACCURATE FINGERPRINT RECOGNITION” which is commonly owned by the assignee of the present invention. The disclosure of this related United States patent application is incorporated herein by reference for all purposes as if fully set forth herein.

### TECHNICAL FIELD OF THE INVENTION

The present invention is directed generally to automated fingerprint recognition, and more specifically, to a device for improving the accuracy and legitimacy of automated fingerprint readers by providing a secure, stable platform for the subject finger during the reading process.

### BACKGROUND OF THE INVENTION

Fingerprints provide a unique way of determining an individual's identity. Even in the absence of identifying scars or markings, the natural undulations in the skin on the tip of one's finger form a pattern that for most purposes may be considered to be unique. Many years ago it was discovered that a close examination of a person's fingerprints could be used to determine if the person was in fact the person he or she claimed to be (or was thought to be). Not only that, it was also discovered that a person touching an object with the fingertips often leaves behind residue that forms a fingerprint pattern. The presence of this residue might be highlighted with the use of a dusting powder so that the pattern becomes clearly visible, and the person or persons that recently touched the object might thereby be identified.

A familiar use of this technique may be found in many detective novels, where it may be used to catch a thief or other villain. Of course, it is often just as useful for such purposes in real life as well. Particularly where the perpetrator of a crime does not employ sufficient forethought to make sure that no fingerprints are left behind, the presence of the perpetrator at a crime scene may be quickly established through the use of identifying fingerprints. In some cases the absence of such evidence may also serve to exonerate the innocent.

Fingerprint identification may also be employed outside of the crime scene context. In some instances, a person may wish to be uniquely identifiable in some way. For example, a person having a bank account may carry a photo identification (ID) card that also bears a likeness of their fingerprint. The ID card may then be matched at any time with the “print” of a person presenting it, thereby providing an additional assurance that they are in fact the account holder. In this manner access to account funds by imposters is discouraged or thwarted completely. The bona fide fingerprint may be reproduced on a person's driver's license, or even on a personal check itself, in order to avoid the need to carry a separate ID card. In another example, a business that regularly accepts personal checks may simply require that a patron paying in this manner produce a fingerprint that can be retained and associated with the check in the future if a question arises as to whether it was actually the account holder that paid with it.

In similar fashion, the identity of employees, couriers, or security personnel may be more confidently verified using fingerprint comparison. For any such identification system to work effectively, of course, a known person's fingerprint must be obtained and kept available so that the necessary comparison may be made. As mentioned above, one way to do this is using a card on which the print is reproduced, perhaps accompanied by the person's photograph and signature. To the extent such a card can be produced, however, it could also be forged, a fact detracting somewhat from the veracity of the verification process. To overcome this disadvantage, a file containing the fingerprints of many people may be maintained, and organized so that the prints of a given person may easily be retrieved whenever it becomes necessary to confirm an identity.

Fingerprints may be reproduced by applying ink to one of the subject's fingertips and then pressing it onto a card or sheet of paper. (Other, similar media may be used as well.) With the proper amount of ink and pressure, fairly accurate copies may be obtained. A human attendant is often present at the fingerprinting process in order to assist the subject in performing the operation properly and to verify that an accurate reproduction has been made. The process is often repeated for all of the fingers, producing a “set” of prints. A note is made of the subject's identity, and the sheet or card bearing the set is stored until needed for future reference.

With a great many people to identify, however, the organization of so many records becomes cumbersome. In addition, the opportunity for human error in the comparison process becomes greater. In many situations, cost of maintaining a human presence to retrieve and compare the fingerprints is prohibitive. All of these problems have been addressed in recent times through the use of automated fingerprint analysis.

For automated (electronic) fingerprint systems to come into being, several hurdles had to be overcome. Initially, the fingerprint image itself had to be digitally represented in order to store it in a database. Various techniques for storing graphic images have been developed to make such databases feasible. With such techniques came also the ability to draw or print out a reproduction of the fingerprint when necessary. Further advances in technology permitted the comparison itself to be automated, and generally with more accurate results than if a human were making the same comparison. And presented with a fingerprint, the computer performing the comparison can rapidly search the database (perhaps containing thousands of records) for matches to determine if the print matches any one of them.

The electronically stored fingerprint records may be captured by machine as well. FIG. 1 is a simplified sketch illustrating the typically essential components of a fingerprint capturing system 100 according to an embodiment of the prior art. To obtain a fingerprint, the subject places a finger 101 on the plate 105. Plate 105, for simplicity shown here in cross section, is generally made of a transparent material such as glass or plastic. Although the extent of plate 105 is not illustrated in FIG. 1, it may be of any size that will accommodate the fingers of anticipated users.

Disposed on the opposite side of plate 105 from the subject finger are illumination sources 110, which may be on continuously or may “flash” in order to temporarily illuminate the finger. Light from illumination sources 110 passes through the plate 105 to finger 101, from which some of the light is reflected back though plate 105. Light passing back through plate 105 is focused by lens 115 so that an image of the finger, and specifically a fingerprint, may be captured by image capturing device 120. Image capturing device 120 may be a standard charge coupled device (CCD) or similar apparatus. The image captured by CCD 120 is read out in electronic form under the direction of controller 125, and then transmitted to be stored in a database or analyzed by a processor (not shown) that is associated with the fingerprint capturing system 100.

This simple system 100 described above is intended to obtain for storage and analysis a copy of the “fingerprint,” or pattern formed by small skin undulations on the anterior side 102 of finger 101. FIG. 2 is a front view of finger 101 where anterior side 102 may be seen to exhibit such a pattern. As mentioned above, this pattern is typically unique to the individual possessing it and can therefore be used for identification. The broken line in FIG. 2 delineates the “fingerprint” area itself. Note this area is most usually defined as that area outward of skin crease 106, which is associated with the distal knuckle of finger 101.

Note that although not shown in FIG. 1, the fingerprint pattern typically extends somewhat around the sides 104 and the fingertip 103. In order to capture more of the pattern, the finger may be rolled from side to side. This operation is somewhat easier where an inked print is being produced on a fingerprint card than when using an automated reader such as is illustrated in FIG. 1 and described above. To obtain a “rolled” print, the image capturing device 120 would have to be capable of capturing a moving image or be programmed to take multiple images. The processor would also have to be able to effectively analyze such images. More often, automated systems will be designed to capture only single “still” images of each proffered finger.

Even so, the problem of finger movement or inaccurate placement may reduce the accuracy with which an automated system such as system 100 can reproduce the fingerprint on anterior surface 102 of finger 101. If the subject's finger moves at the moment when the image is being captured, a suitable reproduction may not be obtained. Finger movement is a major cause of smudges in inked fingerprints.

An automated system minimizes the problem of finger movement because the image capture procedure is virtually instantaneous with respect to human movement. This means that it is more difficult to obtain a blurred image. However, when a blurred image is obtained it is necessary to evaluate the quality of the image and then retake the image if the image quality is unacceptable.

If a “rolled” print is desired, the finger movement problem may be exacerbated because it will require the subject to follow a specific procedure for rolling the finger to produce the desired result. In addition, there may be no attendant to assist in making sure that the procedure is properly executed and with no attempt at deception. One reason for the automated reader in the first place, after all, is to eliminate the need for an attendant.

Therefore, despite the advances that have been made in the field of automated fingerprint reading, there remains a need in the art for an improved fingerprint reader that provides a more suitable fingerprint imaging system for stabilizing a subject's finger during the fingerprinting process and providing some assurance that the fingerprint obtained is legitimate.

### SUMMARY OF THE INVENTION

To address the above discussed deficiencies of the prior art, the present invention introduces an automated finger imaging system that is well suited for accurately capturing and processing fingerprint images for use in identification, security, and other applications. As fingerprints are unique, and tend to remain distinctive throughout the life of an individual, they may be used to verify a person's identity when, for example, advancing funds or controlling entrance to a secure facility.

A particularly useful application of the present invention is one including use of a finger image processor, possibly executing suitable pattern recognition software, that operates to identify similarities between fingerprints being scanned and those already scanned and stored in memory associated with the processor. In some of these applications, the identity verification process will be completely automated.

An exemplary finger imaging system comprises a finger imaging device and a finger image processor. This exemplary system facilitates execution of a reliable methodology for personal identification, and is particularly useful as the basis for, or at least an integral part of, a pattern recognition security access system.

The exemplary finger imaging device comprises a finger receiving surface having an outwardly extending locator bar. The locator bar is located proximate an image capturing window formed in the finger receiving surface such that when a finger is properly positioned the locator bar is received into the anterior crease associated with the digital finger knuckle. The locator bar may be integrally formed with the finger receiving surface or separately attached. If attached, it may be fixed using, for example, an adhesive or mechanical fastener. The locator bar may also be movably attached so that the finger imaging device is size adjustable. The finger imaging device may further comprise an image capturing device, such as a charged couple device (CCD), and a controller. The controller is operable to provide an image signal representing at least one image characteristic of a finger positioned at the finger receiving surface. The finger image processor operates to process the image signal as a function of the at least one image characteristic of the finger.

According to a technologically sophisticated embodiment, the locator bar is associated with at least one sensor for sensing a non-image characteristic of the finger being imaged. The sensor may be, for instance, associated with the controller, which is further operable to generate a non-image signal representing the sensed at least one non-image characteristic of the finger. In one implementation hereof, the finger image processor is likewise further operable to processes the non-image signal as a function of the at least one non-image characteristic thereof.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the terms “controller” and “processor” means any device, system or part thereof that controls at least one operation, such a device may be implemented in hardware, firmware or software, or some combination of at least two of the same. It should be noted that the functionality associated with any particular controller or processor may be centralized or distributed, whether locally or remotely. Definitions for certain words and phrases are provided throughout this patent document, those of ordinary skill in the art should understand that in many, if not most instances, such definitions apply to prior uses, as well as future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is a simplified sketch illustrating the essential components of a fingerprint reader according to an exemplary embodiment the prior art;

FIG. 2 illustrates anterior of a fingertip bearing a fingerprint such as might be reproduced with the aid of the device of the present invention;

FIG. 3 is an isometric view of a finger imaging device according to an exemplary embodiment of the present invention;

FIG. 4 is an isometric illustration of a finger imaging device according to another exemplary embodiment of the present invention;

FIG. 5 is a partially cut away side view illustrating selected components of the finger imaging device similar to that of both FIGS. 3 and 4;

FIG. 6 is the partially cut away side view of the finger imaging device of FIG. 5 illustrating the position of a subject finger as it is being positioned for fingerprinting;

FIG. 7 is the partially cut away side view of the finger imaging device of FIG. 5 illustrating a fingertip in place for accurate fingerprinting according to an exemplary embodiment of the present invention; and

FIG. 8 illustrates an image capturing system utilizing a finger imaging device according to an exemplary embodiment of the present invention.

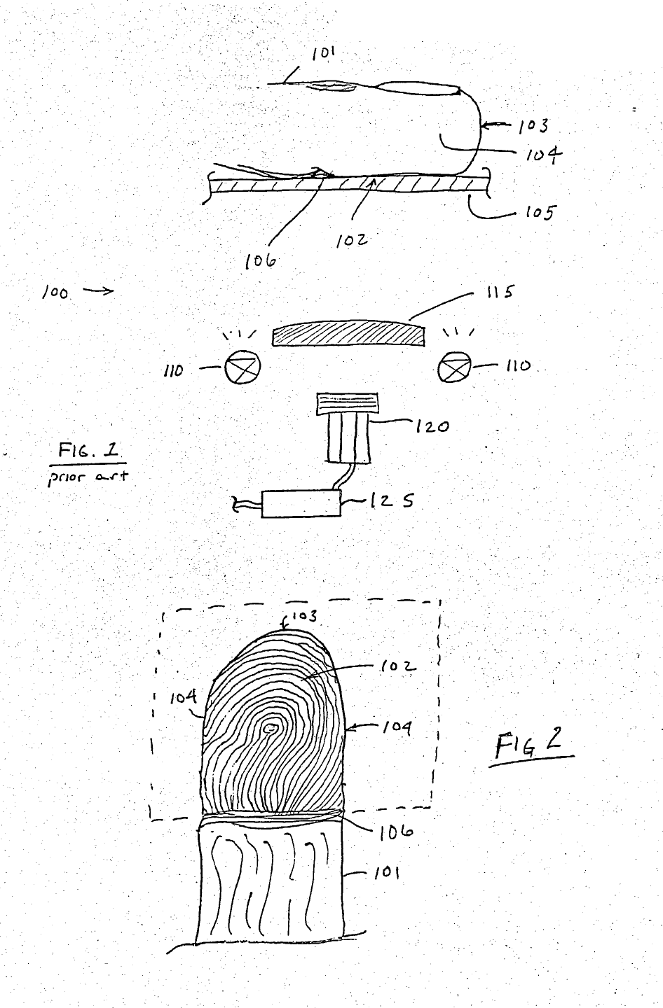

### DETAILED DESCRIPTION OF THE INVENTION

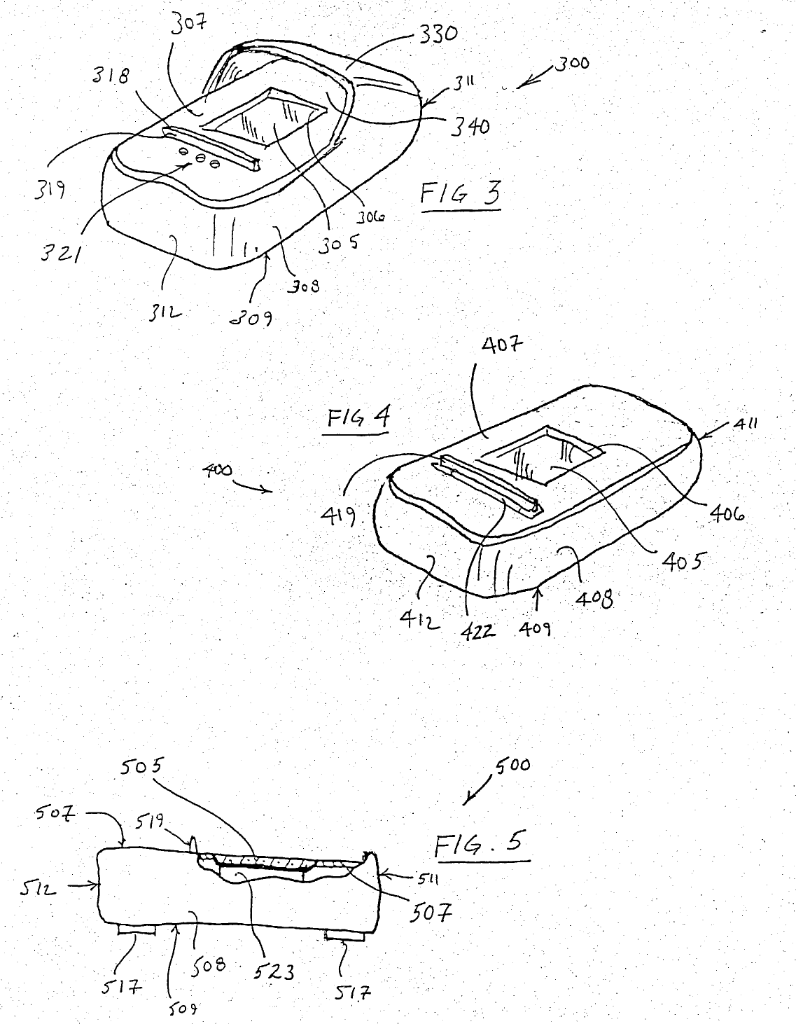

FIGS. 3 through 8, discussed below, and the various embodiments used to describe the principles of the present invention in this patent document are by way of illustration only and should not be construed in any way to limit the scope of the invention. Those skilled in the art will understand that the principles of the present invention may be implemented in any suitably configured biometric device.

The present invention is directed toward a more accurate and consistent image capturing system for capturing the images of fingerprints, the system having a finger imaging device including a locator bar for assisting the subject in proper finger placement, for helping to keep the finger steady during the image capturing process, and sometimes for manipulating it into a desired motion. The various components of the finger imaging device will now be described in more detail. Note that where there is a similarity with the standard imaging system of the prior art, or between the different embodiments, analogous though not identical reference numbers will be used. In this regard, note that the repetition (or absence) of certain features from one exemplary embodiment to another does not necessarily indicate that they are required (or prohibited) features. The required features, of course, are specifically set forth within the claims.

FIG. 3 is an isometric illustration of a finger imaging device 300 according to an exemplary embodiment of the present invention. Finger imaging device 300 includes a transparent plate 305 mounted within an imaging window 306 where the subject's finger will be placed in order to capture an image of the fingerprint. Window 306 is formed in the finger receiving surface 307 of finger imaging device 300. Finger receiving surface 307, along with bottom 309, sides 308, fore end 311, and back end 312 form an enclosure for the internal components (not shown in FIG. 3) of finger imaging device 300. Note that in an alternate embodiment (not shown) finger receiving surface 307 may itself be transparent, in which case, of course, no separately formed window is necessary. No specific internal components are required by the present invention, but they will typically include an illumination source and CCD, along with the controller, circuitry, and other components necessary to transmit the captured image. For simplicity, these internal components, which form part of the invention only where explicitly recited, are otherwise referred to only generally.

In the embodiment of FIG. 3, finger imaging device 300 also includes a shield 330 which is integrally formed with the sides 308 and fore end 311 of finger imaging device 300. When present, shield 330 acts to protect the plate 305, and encourages the subject to approach the plate 305 from the desired direction, so as to properly utilize the locator bar 319 of the present invention, as will be described below. The shield 330 may also act to stabilize the subject finger as it creates, along with finger receiving surface 307, a recess 340 for receiving the finger to be fingerprinted. The recess 340 may be so formed to approximate the size and shape of the fingertips expected to be received.

The shield 330 may also be a guide, and the advantages of such a feature are described in detail in U.S. patent application Ser. No. [Attorney Docket No. STMI01-01116], referred to above and incorporated herein by reference. As recited there, the shield 330 acting as a guide may also comprise an inflatable bladder or resilient pad that may cooperate with locator bar 319 to stabilize the finger in its proper position.

Locator bar 319 extends outwardly from finger receiving surface 307. Locator bar 319 is a ridge on which a subject finger will be rested during the fingerprinting process. The locator bar 319 may be integrally formed with finger receiving surface 307 or be a separate structure that is attached to it, or it may outwardly protrude through an opening formed in finger receiving surface 307. Locator bar 319 is not required to be of any definite shape, but is positioned so that it will correspond with the skin crease 106 of the distal joint of the subject finger when it is in place for fingerprinting (as shown in FIG. 7).

Locator bar 319 has several advantages. It assists the subject in properly placing his or her finger for imaging, and ensures that a person will consistently place his or her fingertip in basically the same position. In an alternate embodiment (not shown in FIG. 3) the locator bar 319 is operable to move so that each end of it can be raised and lowered. In this alternate embodiment, locator bar 319 may be thus operated with the subject finger 101 in place, alternately raising one side 104 of the finger and then the other. A finger so manipulated may produce the “rolling” type fingerprint described above. The action assists the subject in properly performing the correct rolling procedure and alleviates the need for a human assistant. Locator bar 319 may also include an electrostatic discharge (ESD) shunt (not shown) for discharging any static electricity associated with the subject finger.

The use of a locator bar 319 helps ensure both the integrity and the legitimacy of the captured fingerprint. With respect to the integrity of the captured fingerprint, locator bar 319 helps to position a finger in the same position each time, so that a misidentification does not occur simply because the subject has been careless in the placement of his or her finger. The need to “legitimate” the print requires a brief explanation.

Although fingerprints are unique, they may be artificially created and reproduced. If a fingerprint is, for example, copied onto a piece of rubber or plastic stock, the resulting object may be used to “trick” the automated system into believing the actual subject has presented a finger for imaging. If a false identity match is produced, the wrong person may be admitted to a secure area where they are not allowed, or given access to funds that are not their own. Moreover, the “counterfeit” fingerprint may be copied surreptitiously from an object touched by the actual fingerprint bearer, meaning that obtaining it may not be all that difficult.

Locator bar 319 on finger receiving surface 307 may help avoid such deception by causing the subject finger to be received in a relatively certain position. Any counterfeit would have to include this additional characteristic, which may not be obtainable from a “lifted” fingerprint. In addition, in one embodiment locator bar 319 includes one or more sensors for sensing non-image information from the subject finger. This non-image information may be, for example, the temperature or dampness of the offered finger, or the pulse rate or blood pressure of the subject. (Where a variable volume guide bladder is used, the systolic and diastolic blood pressure readings may even be obtained.) Although these characteristics may vary to some degree even in the same individual, they may be difficult to accurately reproduce within a reasonably expected range by using a rubber or plastic object that merely bears the subject's fingerprint. The non-image information collected by the sensors in locator bar 319 may substantially frustrate any attempt to trick the imaging system. While a variety of these non-image characteristics may also be artificially produced, the equipment required to do so reliably might be too conspicuous for covert use. A video camera in the general area might be sufficient to discourage an attempt to do so. Note that while locator bar 319 is a preferable location for the non-image information sensors, they may also be placed in other positions as well, for example in the finger imaging device 300.

Locator bar 319 may also increase the reliability of finger imaging device 300 by acting to “clean” the surface of finger 101 that is about to be fingerprinted. For this purpose it may be made or covered by absorbent material, made of rubber, or provided with a square edge as illustrated in FIG. 3 as opposed to being rounded. As the finger is moved into position, the cleaning action of scrapping by locator bar 319 helps to remove perspiration, body oils, foreign materials, and so forth. Note that in this embodiment, maximum advantage may be gained by forming the recess 340 to be relatively small, encouraging the subject to press the finger against locator bar 319 instead of lifting over it. This effect may also be accomplished by other suitable structures, of course, or by placing finger imaging device 300 into a relatively confined space.

As shown in the embodiment of FIG. 3, locator bar 319 preferably has a squared (or acute) edge 318 for cleaning, and described above. In addition, one or more openings 321 are formed in finger receiving surface 307 on the side of locator bar 319 opposite window 305. Openings 321 may be mere recesses, capillary tubes, or larger openings through finger receiving surface 307, and permit some or all fluids to pass. This may simply be for cleaning purposes, but fluids so collected may also be analyzed. Again, mainly as an attempt to thwart deception, the analysis might simply detect the presence of fluid, confirm that it appears to be of human origin, or actually compared it to a database for confirming individual identity. In a preferred embodiment, a vacuum may be created to provide the passage of fluids through openings 321. A separate internal chamber (not shown) would be desirable to prevent collected fluids from damaging the internal components. Provision for cleaning the separate chamber would, of course, also be of advantage.

FIG. 4 is an isometric illustration of a finger imaging device 400 according to another exemplary embodiment of the present invention. Note again that its features corresponding to features of the embodiment of FIG. 3 are analogously but not identically numbered. The embodiment of FIG. 4 lacks the shield 330 shown in FIG. 3. This absence is for illustration rather than necessity, but may be preferable in some applications, for example where an external video camera for capturing an image of the subject could also be used to “witness” the placement of their finger into the finger imaging device 400. As mentioned above, this is one way that deceit may be discouraged or detected.

In the embodiment of FIG. 4, locator bar 419 is movably attached to finger imaging device 400. Connected to a movement mechanism (not shown) inside, it protrudes through opening 422 formed in finger receiving surface 407. The movement mechanism will alternately raise opposing sides of the locator bar 419 (perhaps simultaneously lowering the other side) to encourage finger roll. Naturally, coordinating the movement mechanism with the image capturing process will produce the best results.

FIG. 5 is a partially cut away side view illustrating selected components of the finger imaging device 500, which is similar to that shown in both FIGS. 3 and 4. In this view, internal components 523 are generally illustrated, mounted below glass plate 505. Also visible are pedestals 517 which may be used to support the finger imaging device 500, or alternately to anchor it to the surface on which it is disposed. Locator bar 419 may be seen extending above finger receiving surface 507.

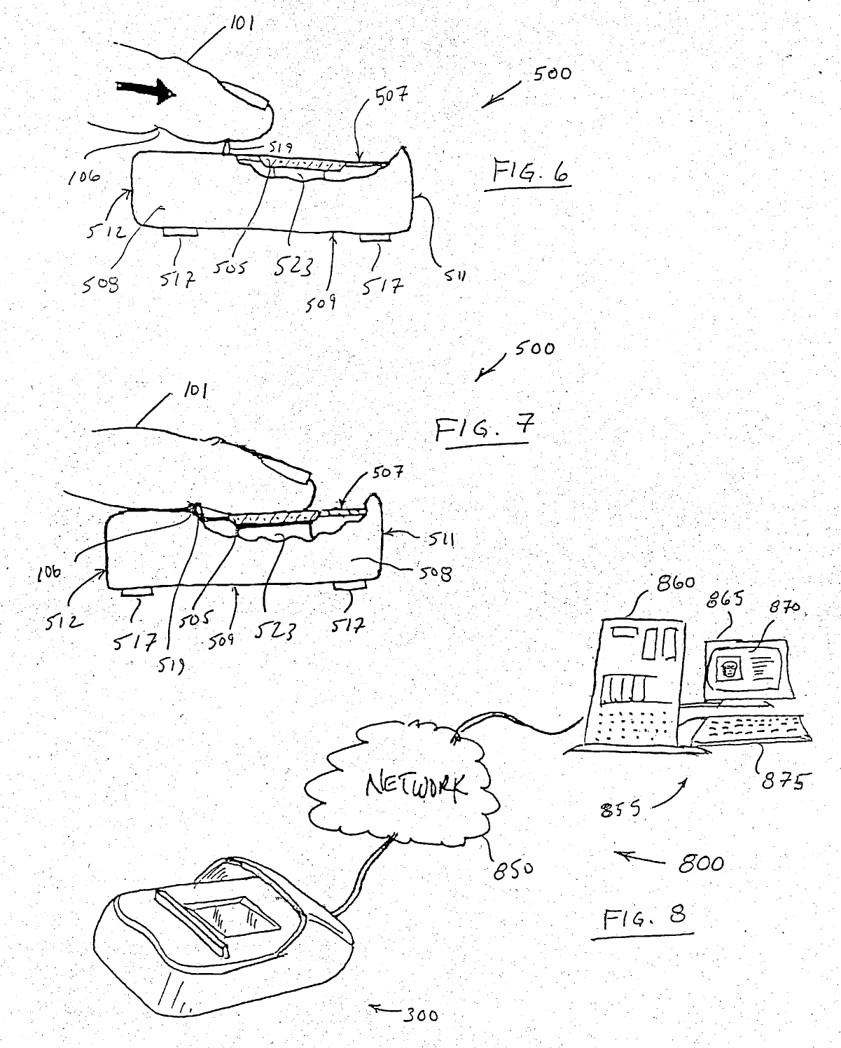

FIG. 6 is a partially cut away side view of the finger imaging device 500 of FIG. 5 illustrating the position of a subject finger at the point of being inserted for fingerprinting. As indicated by the arrow, finger 101 is properly inserted in a direction towards the fore end 511 of finger imaging device 500, scraping the anterior tip 102 along locator bar 519. FIG. 7 is a partially cut away side view of the finger imaging device 500 of FIG. 5 illustrating a fingertip in place for accurate fingerprinting according to an exemplary embodiment of the present invention. With the subject finger 101 fully inserted, its crease 106 rests on locator bar 519. A separate sensor (not shown) may be used to indicate that the finger 101 is now in the proper position, or the controller may determine this simply from the image it received from the image capturing device.

FIG. 8 illustrates an image capturing system 800 using a finger imaging device 300 according to an advantageous embodiment of the present invention. In the embodiment of FIG. 8, a finger imaging device 300 is in communication with a communication network 850. The network 850 may, for example, be a small network such as a local area network (LAN) , or may be the Internet, or may be a large virtual private network (VPN). Although a wired connection to the network 850 is shown in FIG. 8, the connection could also be wireless, for example using a radio frequency (RF) or infrared (IR) communication system. Also connected to the network 850 is a computing entity 855, which in this embodiment includes a personal computer (PC) 860, a display monitor 865, and a keyboard 875. The PC 860 contains both data storage media and a processor (not shown).

The image captured by finger imaging device 300 is transmitted to computing entity 855 where it is analyzed or stored according to the design of the system. For example, where the purpose of the system is to verify identity, the subject may (prior to offering a finger for fingerprinting) enter a personal identification number (PIN) on a keypad (not shown) located at or near the finger imaging device 300. Or the necessary input devices may be provided for the subject to orally pronounce the PIN or simply give their name.

When the fingerprint image is captured and transmitted to the computing entity 855, it can be compared with a reference fingerprint that has been stored there. If the fingerprints match, then the subject's identity has been confirmed. Alternately, in another application, the subject's fingerprint may simply be captured and transmitted to the computing entity 855, when then searches a database for a fingerprint that matches the one it has just received. When a match is found, information regarding the person associated with the stored fingerprint may be displayed on the screen 870 of display monitor 865. If present, a security officer may use the keyboard to direct the system to open a door, or may request additional information from the subject. While in this application the need for a human attendant is reintroduced, a single security officer may be able, though network 850, to monitor input from dozens of finger imaging devices like finger imaging device 300. Of course, more than one computing entity may be used as well. In another advantageous embodiment (not shown) the finger imaging device 300 may simply be connected directly to one or more computing entities. In fact, the computing entity may even be physically co-located in the same cabinet or case as the finger imaging device 300.

Although the present invention has been described in detail, those skilled in the art should understand that they could make various changes, substitutions and alterations herein without departing from the spirit and scope of the invention in its broadest form.

What is claimed is:

1. A finger receiving surface for use with a finger imaging device, said finger receiving surface comprising a locator bar for engaging a crease of the finger presented for imaging.

2. The finger receiving surface as set forth in claim 1, wherein said locator bar is fixedly attached to the finger receiving surface.

3. The finger receiving surface as set forth in claim 1, wherein said locator bar is movable attached to the finger receiving surface.

4. The finger receiving surface as set forth in claim 1, wherein said locator bar protrudes through an opening formed in the finger receiving surface.

5. The finger receiving surface as set forth in claim 1, wherein said locator bar comprises a conductive portion for providing a path for the discharge of static electricity, if any.

6. The finger receiving surface as set forth in claim 1, wherein said locator bar comprises at least one sensor for collecting non-image information associated with a finger being presented for imaging.

7. The finger receiving surface as set forth in claim 6 wherein said at least one sensor detects a pulse associated with a finger being presented for imaging.

8. A finger imaging device comprising:
a finger receiving surface;
a locator bar extending outwardly from said finger receiving surface;
an image capturing device positioned to capture the image of a finger placed on said finger receiving surface; and
a controller coupled with said image capturing device that provides an image signal representing at least one image characteristic of a finger positioned at said finger receiving surface.

9. The finger imaging device as set forth in claim 8, further comprising a shield located proximate to said finger receiving surface.

10. The finger imaging device as set forth in claim 8 wherein said locator bar protrudes through an opening formed in said finger receiving surface.

11. The finger imaging device as set forth in claim 10, further comprising a movement mechanism connected to said locator bar for causing said locator bar to move.

12. The finger imaging device as set forth in claim 8, further comprising a sensor for sensing at least one non-image characteristic associated with a finger being presented for imaging.

13. The finger imaging device as set forth in claim 12, wherein said at least one sensor is a blood pressure sensor.

14. The finger imaging device as set forth in claim 12, wherein said at lest one sensor is a temperature sensor.

15. The finger imaging device as set forth in claim 8, further comprising a shunt for discharging a static charge associated with a finger being presented for imaging.

16. A finger imaging system comprising:
a finger imaging device comprising:
a finger receiving surface;
a locator bar extending outwardly from said finger receiving surface;
an image capturing device positioned to capture the image of a finger placed on said finger receiving surface; and
a controller coupled with said image capturing device that provides an image signal representing at least one image characteristic of a finger positioned at said finger receiving surface; and
a processor coupled to receive said image signal from said controller.

17. The finger imaging system as set forth in claim 16, further comprising at least one sensor for collecting non-image information associated with a finger being presented for imaging.

18. The finger imaging system as set forth in claim 17, wherein the at least one sensor is mounted as a portion of said locator bar.

19. The finger imaging system as set forth in claim 16, further comprising a database for storing fingerprint information.

20. The finger imaging system as set forth in claim 16, further comprising a network interface for connecting said finger imaging system to a communications network.

21. The finger imaging system as set forth in claim 16, wherein said controller is coupled to said processor through said network.

22. The finger imaging system as set forth in claim 16, further comprising a moisture detector for detecting moisture associated with a finger being presented for imaging.

23. The finger imaging system as set forth in claim 16, further comprising a moisture analyzer for analyzing moisture collected at said finger receiving surface.

24. The finger imaging system as set forth in claim 16, further comprising a vacuum for creating a pressure differential at said finger receiving surface to promote the collection of moisture.
